(19) United States
(12) Patent Application Publication
(10) Pub. No.: US 2007/0125128 A1
(43) Pub. Date: Jun. 7, 2007

(54) Optical fiber perform cone shaping or preparation method

(76) Inventors: Sanket Shah, Aurangabad (IN); Padmanaban Chinnaiya, Aurangabad (IN)

Correspondence Address: JAMES RAY & ASSOCIATES, 2640 Pitcairn Road, Monroeville, PA, 15146, US

(21) Appl. No.: 11/636,072

(22) Filed: Dec. 8, 2006

(30) Foreign Application Priority Data
Oct. 9, 2006 (IN) 1662/MUM/2006

(51) Int. Cl. C03B 37/018; C03B 37/10

(52) U.S. Cl. 65/414; 65/422; 65/428

(57) ABSTRACT

A process for shaping or preparation of a preform cone of desired shape and dimensions including diameter is provided. The process is characterized by preparing the preform cone either at the mother preform stage or at daughter preform stage without requiring the step of heating the preform end of the mother preform or the daughter preform to a very high temperature and without requiring a step of cooling of the preform cone thus prepared wherein the preform cone is prepared by cutting the preform end or shaping the preform cone at one end of the mother preform or daughter preform by employing a high pressure water-jet. A mother preform and daughter preform having preform cone of desired shape and dimensions, and optical fiber produced from said mother preform and said daughter preform are also provided.

### FIELD OF THE INVENTION

The present invention relates to optical fiber preform cone shaping or preparation method. Particularly, the present invention relates to a method for shaping or preparing optical fiber preform cone having desired shape and dimensions including diameter. More particularly, the present invention relates to a method for shaping or preparing a cone of the preform so as to make it suitable for drawing the fiber and at the same time saving wastage of ends of the preform, and process time and process energy to make the overall process highly convenient and economical. The present invention also relates to optical fiber preform produced while employing method of the present invention, and to the fiber produced from such preform.

### BACKGROUND OF THE INVENTION

Optical fibers are inherently versatile as a transmission medium for all forms of information, be it voice, video or data. The optical fibers are drawn from an optical fiber preform. The optical fiber of predetermined dimension is drawn from the optical fiber preform by subjecting one end of the preform to a high temperature, for example above 2000° C. Under such a high temperature, the tip of the preform softens, from which a thin fiber of desired dimension is drawn. The different methods employed in manufacture of these preforms are described in the literature.

The optical fiber preform can be manufactured by different methods of chemical vapour deposition (CVD). The optical fiber preform manufacturing process primarily involves a step of preparing the core rod comprising core of the fiber and part of clad which may be followed by over-cladding. The core rod can be prepared by methods known in the art, such as modified chemical vapour deposition (MCVD), plasma chemical vapour deposition (PCVD), Atmospheric chemical vapour deposition (ACVD), vapour axial deposition (VAD) etc. The over-cladding of the core rod can also be carried out by various methods, such as glass tube jacketing, ACVD soot over-cladding, VAD soot over-cladding, plasma over-cladding etc. The optical fiber preform can be manufactured by any combination of the core rod manufacturing methods and the over-cladding preparation methods.

The soot over cladding method has been disclosed in co-pending Indian patent application no. 1073/MUM/2005 (herein after IPA1073) a reference to which is drawn here. In accordance with the one of the preferred embodiments of the method disclosed in IPA1073, the opposite ends of the core rod are heated by heating means provided towards opposite ends of the core rod to achieve a predetermined temperature, and this step is continued while maintaining the predetermined temperature of the opposite ends of the rod till a soot porous body of a minimum diameter is formed, and this step of heating the opposite ends is further continued while increasing the predetermined temperature of the opposite ends of the rod and while depositing the soot particles thereon to achieve a particular temperature and an intermediate diameter of the soot porous body, which is further continued while maintaining the particular temperature of the opposite ends of the rod till a soot porous body of a desired diameter is formed.

The method disclosed in IPA1073 has been found suitable for achieving desired diameter and for avoiding problems of physical defects such as cracks, breakages, damages, bends, splits or slippages at the opposite ends of the soot porous body meaning thereby this method results in production of the preform having desired cone shape at the opposite ends thereof. However, the IPA1073 method does not address the problems encountered during the process step of cone preparation just before the step of fiber draw. Even in accordance with IPA1073, one need to perform the step of heating the preform end to a very high temperature of about 2000° C. to finally have a cone of desired shape, which is suitable for start of fiber draw step to finally draw the fiber without having breakage and also to reduce the loss of fiber length during start of fiber draw step. Accordingly, the IPA1073 also suffers from the essential requirement of heating the preform end to finally achieve the desired cone shape just before the fiber draw step to finally draw the fiber.

Accordingly, in accordance with methods as known in the prior art, the fiber draw step is performed while heating the preform end to a very high temperature of about 2000° C. However, desired shape of cone formation in drawing stage before the fiber draw step consumes more than one hour for each preform, which will reduce the productivity of optical fiber.

In order to eliminate the cone formation step at drawing stage and to increase the productivity, the cone formation is prepared separately from the drawing furnace by heating means as known in the prior art.

The main problem of preparation of cone having desired shape which is suitable for start of fiber draw step at one of the opposite ends of the preform by heating the respective opposite end is that the preform bottom end needs to be loaded in a specially built furnace to heat the preform to a very high temperature of the order of about 2000° C. Further, if the cone is prepared at one of the preform ends by step of heating and such preform is required to be stored before drawing the fiber, then the preform is required to be cooled to a temperature suitable for safe handling and storage, which can only be achieved by loading the preform from the step of heating in a specially built containers or vessels comprising proper cooling systems for the step of cooling.

Therefore, the known methods of preparing the cone of desired shape by heating not only suffer from the drawbacks of requiring a step of heating the preform in a specially built furnace to a very high temperature of the order of about 2000° C. and requiring specially built containers or vessels comprising proper cooling systems for loading of preform for the step of cooling, that is also suffer from the problem of requiring additional process step of cooling the preform after preparation of cone of desired shape if the preform has to be stored for fiber draw at a later stage.

Further, it has been observed that the cooling of the preform has to be performed very carefully in a highly controlled manner, because non-uniform cooling or immediate cooling or abrupt cooling has been shown to cause physical defects and stress formation in the preform cone. It has been observed that physical defects and stress in the preform cone leads to transmission loss in the resulting optical fiber or distort other optical parameters, for example, polarization mode dispersion, cutoff wavelength etc. Therefore, the step of cooling the cone prepared by step of heating additionally also requires specially designed cooling means suitable for performing the controlled cooling of the preform so as to avoid occurrence of physical defects, stress formation etc. in the cone prepared.

Therefore, the known processes for preparation of cone of desired shape just before the fiber draw step are not only highly time consuming and power or energy consuming, but are also highly complicated and uneconomical for commercial applications, because of requirement of specially built furnaces with specially designed heating means for example burners of hydroxyl flame, heating by graphite resistance or induction furnace, or by plasma heating means, power full heating means of laser, like carbon dioxide laser etc. for heating the preform end and requirement of specially designed containers or vessels comprising proper cooling systems for loading of preform to have cooling in highly controlled manner.

The hydroxyl flame which is commonly used for cone preparation has been observed to result in increase of hydroxyl contents of the preform, which in-turn has been observed to result in increased transmission loss, particularly at about 1380 nm wavelength band meaning thereby the preform is not suitable for CDWM (16 Channels) applications.

Further, the use of commonly used hydroxyl flame also results in wastage of the glass during the cone cutting process.

The heating by graphite resistance or induction furnace has been observed to cause graphite oxidation which results in formation of oxidation products, for example ash, graphite particles etc. which adheres to the preform surface, and such contamination of the preform with unwanted particles results in production of a preform which will produce a fiber having transmission loss and poor strength.

The lasers, such as carbon dioxide lasers, which are clean heat source to operate, also suffer from the drawback of consuming high power to generate required high temperature meaning thereby there is increase in overall production cost. Further, with use of lasers, one cannot produce preform cones of higher diameter.

Further, it has also been observed that large amount of thermal induced stress in the preform cone area may shatter the preform to pieces.

It has been further observed that whatever, one may do to have controlled heating and controlled cooling, even then by the known methods of preparation of the preform cone by step of heating followed by step of cooling, one cannot have precisely controlled cone of desired shape and dimensions which can be suitable for start of fiber draw without wastage of preform meaning thereby one cannot have preform cone of predetermined shape and dimensions including desired diameter.

It has also been observed that above problems and limitations of the known methods involving step of heating followed by step of cooling are further enhanced when cone is being prepared on a preform having larger diameter say for example more than about 100 mm diameter. Therefore, with known methods of preparation of the preform cone by step of heating followed by step of cooling, one cannot have preform cone having desired cone shape and dimensions, particularly when preform cone is to be prepared on a preform having larger diameter meaning thereby the preform cone thus prepared will not be suitable for start of fiber draw without wastage of preform.

Further drawback of the preform cone preparation by heating step is that the preform has to be placed inside the furnace, the gap between the furnace and preform needs to be sealed properly, otherwise the graphite heating material will get oxidized thus particles will adhere to the outer surface of preform and/or cone.

In order to overcome the problems and limitations of the known method of cone preparation, a cone preparation apparatus and method have been proposed in a co-pending patent application, wherein the cone of desired shape and dimensions including diameter can be prepared by grinding or cutting preform end of a soot preform comprising soot porous body having overcladding [hereinafter referred to as soot preform] by employing a grinding or cutting means. However, the method and apparatus disclosed in the co-pending application have been found to be suitable only at the soot preform stage, and not at the mother preform stage and daughter preform stage, which are the commonly used stages for drawing the fiber of desired characteristics.

It has been observed that method of cone preparation by grinding or cutting the preform end of the soot preform by employing a grinding or cutting means suffers from problem of contamination of the soot preform on sudden failure of suction means. On sudden failure of suction means, the soot particles removed during cutting or grinding of the soot preform may get deposit on soot preform meaning thereby cone preparation by cutting or grinding of the preform end by cutting or grinding means may result in total loss of soot preform if suction means fails suddenly during the cone preparation.

### NEED OF THE INVENTION

Therefore, there is a need to have a method for preparing desired cone shape of the preform by avoiding step of heating the preform end in order to overcome all associated disadvantages, drawbacks and limitations of the step of heating the preform end, and hence by avoiding the step of cooling the preform end after preparation of preform cone, and still being suitable at the mother preform stage and daughter preform stage, which are the commonly used stages for drawing the fiber of desired characteristics.

### OBJECTS OF THE INVENTION

Accordingly, the main object of the present invention is to provide a method for preparing desired cone shape of the preform which does not require any step of heating of preform end meaning thereby which overcomes all associated disadvantages, drawbacks and limitations of the step of heating the preform end as described herein, and hence also overcomes all associated disadvantages, drawbacks and limitations of the step of cooling the preform end after preparation of preform cone, and which is still suitable for preparation of the preform cones at the mother preform stage as well as at the daughter preform stage, which are the commonly used stages for drawing the fiber of desired characteristics, and suitable for producing preform cone on an end of the preform having larger diameter say for example more than about 100 mm diameter.

Further object of the present invention is to provide a method for preparing desired cone shape of the preform which also addresses the problems encountered during the process step of cone preparation just before the process step of fiber draw and which is also suitable to produce preform cone having precisely controlled cone of desired shape and dimensions, including desired diameter suitable for start of fiber draw without wastage of preform.

One particular object of the present invention is to provide a method for preparing desired cone shape of the preform, wherein step of heating the preform end to a very high temperature of about 2000° C. is totally avoided/eliminated to finally have a preform cone of desired shape, which is not only suitable for start of fiber draw step to finally draw the fiber but also avoids formation of any defects in the preform cone to avoid possibility of breakage meaning thereby reduces the loss of fiber length during start of fiber draw step results in exorbitant power and energy savings.

Another particular object of the present invention is to provide a method for preparing desired cone shape of the preform, wherein the preform cone having any desired shape and dimensions, including higher diameter can be prepared with ease and convenience and within a short span of time meaning thereby making the overall process not only controlled and convenient, but also highly time saving, and hence, making the overall process highly productive and economical for commercial applications.

Still another particular object of the present invention is to provide a method for preparing desired cone shape of the preform, wherein the preform is not required to be loaded in any complicated and sophisticated and expensive and specially built containers or vessels with proper cooling systems thereby making the overall process further economical for commercial purposes.

Yet another particular object of the present invention is to provide a method for preparing desired cone shape of the preform, wherein the step of cooling of the prepared preform cone to a suitable temperature suitable for safe handling of the prepared preform cone is totally avoided, meaning thereby the object is to have a method for preparing preform cone wherein possibility of non-uniform cooling or immediate cooling or abrupt cooling is totally avoided, and hence, possibility of formation of physical defects and stress in the preform cone is totally avoided which otherwise would have formed if the prepared preform cone is non-uniformly cooled or immediately cooled or abruptly cooled.

Further, particular object of the present invention is to provide a method for preparing desired cone shape of the preform, wherein the preform produced will be suitable to produce a fiber not only having reduced transmission loss, but also having desired other optical parameters, for example, desired polarization mode dispersion, cutoff wavelength etc.

Still further particular object of the present invention is to provide a method for preparing desired cone shape of the preform, wherein the requirement of specially designed heating means, for example hydroxyl flame burners, graphite resistance or induction furnace, plasma heating means, power full laser heating means for heating the preform end is totally avoided, and therefore, the disadvantages associated with such specially designed heating means are totally avoided.

Yet further particular object of the present invention is to provide a method for preparing desired cone shape of the preform, wherein the possibility of increase of hydroxyl contents of the preform during the step of cone preparation is avoided, and hence a preform produced will have reduced transmission loss, particularly at about 1380 nm wavelength band and accordingly the preform produced will be suitable for CDWM (16 Channels) applications.

This is further particular object of the present invention to provide a method for preparing desired cone shape of the preform, wherein the possibility of contamination of preform produced with oxidation products, for example ash, graphite particles etc. is avoided by avoiding the use of graphite resistance or induction furnace, thereby possibility of transmission loss and poor strength of the preform produced is avoided.

This is another particular object of the present invention to provide a method for preparing desired cone shape of the preform, wherein by avoiding use of lasers, such as carbon dioxide lasers for preparation of preform cone losses on account of consumption of high power required to generate required high temperature is avoided meaning thereby the overall production cost is reduced, and possibility of thermal induced stress in the preform cone area which may shatter the preform to pieces is also avoided.

This is still another particular object of the present invention to provide a method for preparing preform cone of desired cone shape and dimensions, wherein it does not suffer from problem of contamination of the preform with the soot or glass particles which are removed while cutting the preform end to form a preform cone or shaping the preform cone of the preform to a desired shape and dimensions.

The other objects and advantages of the present invention will be apparent from the following description when read in conjunction with the accompanying drawings which are incorporated for the purpose of illustration of present invention and not to limit scope thereof.

### BRIEF DESCRIPTION OF THE INVENTION

Therefore, in accordance with the present invention there is provided a method for preparing a preform cone having desired shape and dimensions, including diameter, wherein the step of heating the preform end to prepare the preform cone before start of step of fiber draw and step of cooling the prepared preform cone to a suitable temperature for safe handling and storage of the prepared preform cone if the preform is required to be stored before start of step of fiber draw are totally avoided, because the presently disclosed method is such which neither requires any step of heating for preparation of preform cone nor any step of cooling for cooling or controlled cooling prepared preform cone, and hence, the prepared preform cone will have a temperature suitable for its safe handling and/or storage for fiber draw at a later stage, meaning thereby the presently disclosed method for preparing the preform cone also avoids possibility of non-uniform cooling or immediate cooling or abrupt cooling, and hence, avoids possibility of formation of physical defects and stress in the preform cone which otherwise may form if the prepared preform cone is non-uniformly cooled or immediately cooled or abruptly cooled, and is still suitable for preparation of the preform cone at the mother preform stage as well as at the daughter preform stage, which are the commonly used stages for drawing the fiber of desired characteristics, and is also suitable for producing preform cone on an end of the preform having larger diameter say for example of more than about 100 mm diameter, and also overcomes certain limitations, drawbacks and disadvantages of the prior art as described herein.

The presently disclosed method for preparing preform cone having desired cone shape and dimensions including diameter has been observed to be free from the problem of contamination of the preform with the soot or glass particles which are removed while cutting the preform end to form a preform cone or shaping the preform cone of the preform to a desired shape and dimensions.

It has been observed that present method has advantage over the prior art method in that even on sudden failure of or drop of water-jet pressure, the soot or glass particles removed during the cutting of preform end to form a preform cone having desired shape and dimensions or shaping of the preform cone of the preform to a desired shape and dimensions do not contaminate the preform, because the soot or glass particles wash away with the water from the water-jet.

Accordingly, the present invention, in first embodiment relates to a process for shaping or preparation of preform cone of desired shape and dimensions including diameter characterized in that the preform cone is prepared at the mother preform stage without requiring the step of heating, particularly a step of heating the preform end of the mother preform to a very high temperature, for example of the order of about 2000° C. and without requiring a step of cooling, particularly a step of controlled cooling of the preform cone thus prepared wherein the preform cone is prepared by cutting the preform end or shaping the preform cone at one end of the mother preform by employing a high pressure water-jet.

Accordingly, the present invention, in second embodiment relates to a process for shaping or preparation of preform cone of desired shape and dimensions including diameter characterized in that the preform cone is prepared at the daughter preform stage without requiring the step of heating, particularly a step of heating the preform end of the daughter preform to a very high temperature, for example of the order of about 2000° C. and without requiring a step of cooling, particularly a step of controlled cooling of the preform cone thus prepared wherein the preform cone is prepared by cutting the preform end or shaping the preform cone at one end of the daughter preform by employing a high pressure water-jet.

The other embodiments and advantages of the present will be apparent from the following description when read in conjunction with the accompanying drawings which are incorporated for illustration of preferred embodiments of the present invention and are not intended to limit scope thereof.

### BRIEF DESCRIPTION OF THE ACCOMPANYING DRAWINGS

FIG. 1 illustrates a schematic representation of deposition process over a mandrel to produce a soot porous body.

FIG. 2 illustrates a schematic representation of hollow soot porous body having centerline therethrough after removal of mandrel from the soot porous body.

FIG. 3 illustrates a schematic cross-sectional view of hollow soot porous body having centerline therethrough after removal of mandrel from the soot porous body.

FIG. 4 illustrates a schematic representation of hollow soot porous body in side the sintering furnace after removal of mandrel from the soot porous body.

FIG. 5 illustrates a hollow soot porous body having centerline therethrough after removal of mandrel from the soot porous body which is subjected to steps of dehydration, sintering and collapsing to produce a solid glass preform.

FIG. 6 illustrates a schematic representation of the mother preform comprising a core and a clad provided with handle rod on each of its opposite ends which is employed for preparing a preform cone in accordance with one embodiment of the present invention.

FIG. 6a illustrates a schematic representation of the daughter preform comprising a core rod and overclad which is employed for preparing a preform cone in accordance with another embodiment of the present invention.

FIG. 7 illustrates a schematic representation of the method for preparing a preform cone in accordance with one embodiment of the present invention.

FIG. 8 illustrates a schematic representation of the mother preform having a preform cone prepared in accordance with one embodiment of the present invention.

FIG. 8a illustrates a schematic representation of the daughter preform having a preform cone prepared in accordance with one embodiment of the present invention.

### DETAILED DESCRIPTION AND PREFERRED EMBODIMENTS OF THE INVENTION

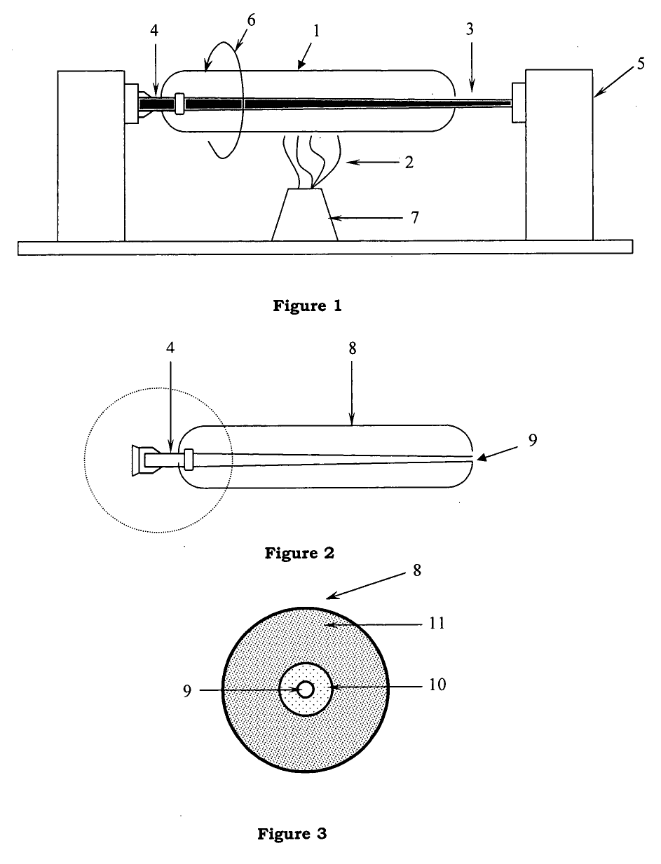

The soot porous body can be prepared by any method known in the art. For example, by atmospheric chemical vapour deposition [ACVD] method. In accordance with a typical process to manufacture a preform, as for example illustrated in accompanying FIG. 1, the preparation of soot porous body 1 comprises the following steps. The glass-forming precursor compounds are oxidized and hydrolyzed to form porous silica based materials 2. The porous silica based materials 2 are deposited on a tapered cylindrical member referred as mandrel 3, which can be any commercially available mandrel with or without any specific preparation, preferably with specific preparation to remove the contaminants therefrom which is provided with a handle rod 4 and fitted on a lathe 5 to form soot porous body 1.

During the step of deposition, the mandrel 3 is rotated in a direction as illustrated by an arrow 6 and also moved along its length with reference to burner 7 to deposit the soot particles 2 on the mandrel 3 for producing soot porous body 1. During the deposition process, the dopant chemicals for example GeCl₄ may also be deposited to form the core of the preform and later the dopant chemicals may be terminated to form clad of the preform. The amount of deposition of the clad region 11 and core region 10 is achieved to have any desired ratio diameter of clad region 11 to the diameter of core region 10.

After completion of deposition, the soot porous body 1 is removed from lathe 5 along with mandrel 3 and handle rod 4, and the mandrel 3 is removed/detached, during the mandrel removal step, from the soot porous body 1 thereby resulting in formation of a hollow cylindrical soot porous body 8 (herein after referred to as hollow soot porous body) having a centerline 9 therethrough [FIG. 2].

The hollow soot porous body 8 thus formed comprises a core region 10 having a centerline hole 9 and a clad region 11 of the optical fiber preform [FIG. 3], and said core region 10 has refractive index greater than that of the clad region 11.

After removal/detachment of mandrel 3 a centerline 9 is created inside the soot porous body 1.

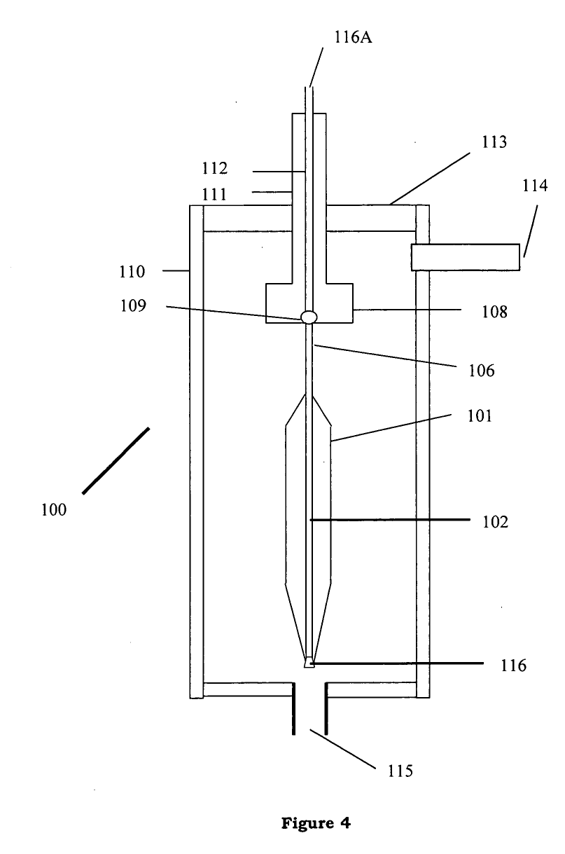

Now referring to accompanying FIG. 4, the prepared hollow soot porous body 101 is transferred to the sintering furnace 100 in order to achieve dehydration, and sintering of the hollow soot porous body 101 to form dehydrated and sintered hollow glass body.

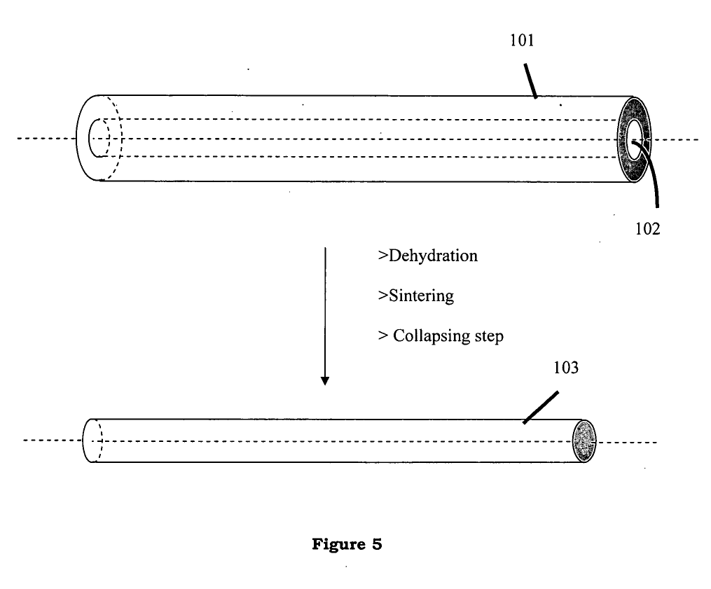

The dehydrated and sintered hollow glass body is subjected to step of collapsing of the centerline 102 to form a solid glass preform 103 [FIG. 5] with or without requiring any step of drilling or grinding or etching of the centerline 9/102 before steps of consolidation and collapsing.

Thus, the prepared hollow soot porous body 101 is dehydrated, sintered and collapsed to convert it into solid glass preform 103.

In one embodiment, the hollow soot porous body 101, one end of which is provided with a plug 116 is inserted inside the furnace 100 with the help of the handle rod 106. The driving mechanism (not shown) facilitates lowering of the hollow soot porous body 101 into the furnace 100. The furnace 100 comprises a glass muffle tube 110 having a diameter sufficient to accommodate the preform 101 and to adequately provide the environment necessary for dehydration, sintering and collapsing. The muffle tube 110 is heated to temperatures necessary for dehydration and simultaneous sintering and collapsing process steps with the heating means (not shown) that is fitted to the sintering furnace 100.

The heating means selected may be suitable to create three heat zones inside the muffle tube 110 over a length. A thermocouple (not shown) provided in the furnace 100 measures the temperature of the hot zones inside the furnace created by the heating means, and the data measurement is fed to the temperature controller (not shown) that controls the temperature inside the muffle tube 110.

The furnace 100 is provided with an inlet port 115 located suitably on the furnace, preferably near the bottom of the muffle tube 110 for supplying desired gases in the furnace. The top end of the muffle tube 110 is closed with the lid 113 to achieve the preferred temperature profile inside the muffle tube 110 and to maintain the same during the dehydration, and simultaneous sintering and collapsing process steps, and to avoid leakage of gases from the muffle tube 110 to the outside environment. A suction port 114 is suitably provided near the top of muffle tube 110 to facilitate evacuation of the gases from the muffle tube 110 as and when required or on completion of the process.

In accordance with the known art methods, the solid glass preform, also referred as mother preform, produced is subjected, in a conventional manner, to a step of reducing the diameter to form a core rod having reduced diameter, which is subjected, in a conventional manner, to a step of overcladding to form a soot preform comprising soot porous body having core rod, also referred as soot preform, which is subjected, in a conventional manner, to a sintering step to form a sintered preform, also be referred as daughter preform, which is subjected to a step of fiber draw to draw the fiber.

It may be noted that for the ease of understanding the soot preform comprising soot porous body having core rod is referred as “soot preform” which may not be confused with “mother preform” or “daughter preform”, and the end of the mother preform and daughter preform where cone is being prepared is referred as “preform end” and the cone prepared on one of end of the mother preform or daughter preform is referred as “preform cone”.

In accordance with the known art, the fiber may be drawn either from the mother preform or from the daughter preform, and hence, the preform cone can be prepared either at the mother preform or at the daughter preform stage, which as described herein above, essentially require performing a step of heating to a very high temperature of the order of about 2000° C. which, if the preform [mother preform or daughter preform] has to be stored, is followed by highly controlled step of cooling the prepared preform cone. These steps of heating followed by controlled cooling are known to suffer from various disadvantages, drawbacks and limitations, as elaborated hereinabove.

Further, as described herein, the method of preparation of preform cone at the soot preform stages by grinding or cutting the preform end of the soot preform has not been found to be suitable for preparing preform cone at mother preform and daughter preform stages.

Therefore, the know art of producing the preform cone at the mother preform stage and at daughter preform stage essentially comprises step of heating essentially followed by step of highly controlled cooling of the prepared preform cone if the same is required to be stored and/or transported to another site for further processing, and the known method suffer from various disadvantages, drawbacks and limitations as described herein above.

The inventors have surprisingly observed that the preform cone can also be prepared at the mother preform stage and at daughter preform stage without requiring any step of heating which may be followed by step of controlled cooling if the preform having prepared preform cone is required to be stored and/or transported to another site before start of fiber draw process step.

Accordingly, the cone shaping or preparation at the mother preform stage and at daughter preform stage has been surprisingly observed to be feasible by cutting one end of mother preform or daughter preform by a water-jet means and has been found to be possible without requiring any step of heating, which, if the mother or daughter preform having prepared preform cone has to be stored, is not required to have step of cooling meaning thereby the cone preparation at mother preform stage or at daughter preform stage by cutting or shaping the preform end with a water-jet means to have a preform cone of desired shape and dimensions including diameter has been found to be possible without requiring any step of heating, particularly a step of heating to a very high temperature of the order of about 2000° C. and any step of cooling, particularly highly controlled step of cooling the preform cone, and hence, it has been found that the preform cone preparation at the mother preform stage and also at daughter preform stage by cutting or shaping the preform end of the mother preform or of daughter preform with a water-jet means to have a preform cone of desired shape and dimensions including diameter does not suffer from disadvantages, drawbacks and limitations of the prior art as elaborated hereinabove.

Accordingly, the present invention, in first embodiment relates to a process for shaping or preparation of preform cone of desired shape and dimensions including diameter characterized in that the preform cone is prepared at the mother preform stage without requiring the step of heating, particularly a step of heating the preform end of the mother preform to a very high temperature, for example of the order of about 2000° C. and without requiring a step of cooling, particularly a step of controlled cooling of the preform cone thus prepared wherein the preform cone is prepared by cutting the preform end or shaping the preform cone at one end of the mother preform by employing a high pressure water-jet.

Accordingly, the present invention, in second embodiment relates to a process for shaping or preparation of preform cone of desired shape and dimensions including diameter characterized in that the preform cone is prepared at the daughter preform stage without requiring the step of heating, particularly a step of heating the preform end of the daughter preform to a very high temperature, for example of the order of about 2000° C. and without requiring a step of cooling, particularly a step of controlled cooling of the preform cone thus prepared wherein the preform cone is prepared by cutting the preform end or shaping the preform cone at one end of the daughter preform by employing a high pressure water-jet.

In accordance with present invention the mother preform and the daughter preform can be prepared by any conventional method, for example the ACVD method as described herein.

Accordingly, the present invention, in one of the preferred embodiments relates to a method for shaping or preparing a preform cone having desired shape and dimensions including diameter, comprising the steps of:—
preparing the mandrel;
placing the mandrel over a lathe;
depositing soot particles on the mandrel to prepare a soot porous body;
removing the mandrel to form hollow soot porous body having capillary therethrough;
dehydrating the hollow soot porous body to form dehydrated soot porous body;
performing sintering step on dehydrated soot porous body to form sintered glass body;
performing collapsing step to collapse the capillary of the sintered glass body to form solid glass preform [the mother preform];
providing handle rod in each of the opposite ends of the mother preform;
   characterized by
performing the step of shaping of preform cone or preform cone preparation on one end of the mother preform to have a preform cone of desired shape and dimensions including diameter by cutting the preform end or shaping the preform cone at one end of the mother preform by a water-jet means; and
performing fiber draw step on the mother preform having preform cone of desired shape and dimensions including diameter to draw the fiber therefrom.

Accordingly, the present invention, in another preferred embodiment relates to a method for shaping or preparing a preform cone having desired shape and dimensions including diameter, comprising the steps of:—
preparing the mandrel;
placing the mandrel over a lathe;
depositing soot particles on the mandrel to prepare a soot porous body;
removing the mandrel to form hollow soot porous body having capillary therethrough;
dehydrating the hollow soot porous body to form dehydrated soot porous body;
performing sintering step on dehydrated soot porous body to form sintered glass body;
performing collapsing step to collapse the capillary of the sintered glass body to form solid glass preform;
performing the step of reducing the diameter of the solid glass preform to form a core rod having reduced diameter;
overcladding the core rod having reduced diameter to form soot preform comprising soot porous body having core rod;
performing sintering step on the soot preform having prepared preform cone to form a sintered preform [the daughter preform];
   characterized by
performing the step of shaping of preform cone or preform cone preparation on one end of the daughter preform to have a preform cone of desired shape and dimensions including diameter by cutting the preform end or shaping the preform cone at one end of the daughter preform by a water-jet means; and
performing fiber draw step on the daughter preform having preform cone of desired shape and dimensions including diameter to draw the fiber therefrom.

In accordance with one of the preferred embodiments of the present invention, the water-jet means may optionally comprise abrasive material.

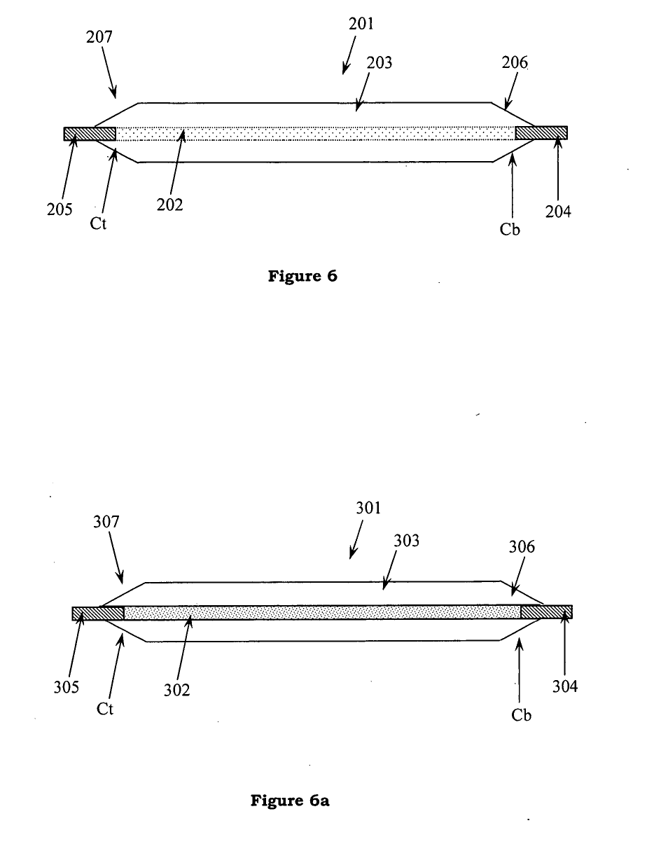

Now referring to accompanying FIG. 6, the mother preform 201 comprises a core 202 and a clad 203 and is provided with dummy glass handle 204 and 205 on each opposite ends 206 and 207 thereof for the purpose of handling and holding the preform during the step of cone preparation by method of present invention. The opposite end 206 [or 207] comprises a cone shape structure Cb [or Ct] wherein preform cone of desired shape and dimensions including diameter can be prepared or shaped by employing method of the present invention.

The accompanying FIG. 6a illustrates the daughter preform 301 comprising a core rod 302 and a overclad 303 wherein the extended parts 304 and 305 on the opposite ends 306 and 307 of the core rod 302 serve the purpose of handle rods on each of the opposite ends of the core rod 302 for handling and holding the preform during the step of cone preparation by method of present invention. The opposite ends 306 and 307 comprise a cone shape structure Cb [or Ct] wherein preform cone of desired shape and dimensions including diameter can be prepared or shaped by employing method of the present invention.

It may be noted that present method can be employed on the mother preform 201 or daughter preform 301 which may not have any cone shape structure on the opposite ends thereof.

In accordance with present invention, the water-jet has been observed to be suitable for shaping the preform end having a cone shape structure to a preform cone having any desired shape and dimensions including diameter as in case of mother preform illustrated in FIG. 6 and daughter preform illustrated in FIG. 6a, and for preparing the preform cone of any desired shape and dimensions including diameter at one end of the mother preform or the daughter preform by cutting the soot or glass at the selected end of the mother preform or the daughter preform.

In accordance with one of the preferred embodiments of the present invention, the step of preform cone shaping or step of preform cone preparation is performed on one end of the mother preform or the daughter preform after holding the preform in a suitable holding mechanism [not shown in figures] so that during the cone shaping or cone preparation step the preform does not get away with the pressure of water-jet.

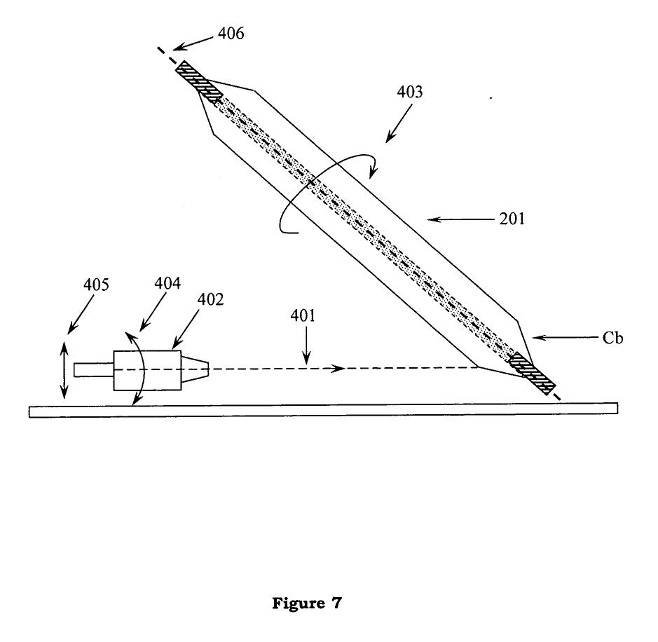

In accordance with one of the preferred embodiments of the present invention, the step of preform cone shaping or preform cone preparation is performed on one end of the mother preform or the daughter preform to have a preform cone of desired shape and dimensions including diameter by cutting the preform end or shaping the preform cone at one end of the mother preform or daughter preform by allowing the water-jet 401 from the water-jet means 402 to fall on the selected end of the preform at an angle, preferably while rotating the preform 201 by rotating means [not shown] about the axis of symmetry 406 in longitudinal direction 403. In accordance with present invention the angle is selected from the range varying from about 40 to 60 degree [FIG. 7] and it has been observed that when preform is held at an angle within the selected range, the preform cone of desired shape and dimensions can be obtained without causing any damage to the preform body. The water-jet means 402 has two degrees of freedom namely it can rotate about an axis as shown by arrow 404 in FIG. 7 and can translate in the plane as shown by arrow 405. These two degrees of freedom of the water-jet means 402 in-addition to rotation of the preform about the longitudinal axis of symmetry 406 and tilting of the preform, preferably in the range of 40 to 60 degrees helps to obtain the desired cone shape and diameter.

In a preferred embodiment of the present invention, a software is designed to control the movements of the preform [angle at which it is tilted and the rotation speed], the water-jet means movement and the water-jet pressure to obtain desired perform cone shape.

In accordance with one of the preferred embodiments of the present invention, the step of preform cone shaping or preform cone preparation is performed on one end of the mother preform or the daughter preform to have a preform cone of desired shape and dimensions including diameter by cutting the preform end or shaping preform cone at one end of the mother preform or daughter preform by allowing the water-jet 401 from the water-jet means 401 to fall on the selected end of the preform at a pressure. In accordance with present invention the pressure is selected from a range varying from about 4000 to 8000 Kg/Cm² and it has been observed that when water-jet is made to fall on the selected end of the preform, the preform cone of desired shape and dimensions can be obtained without causing any damage to the preform body.

In accordance with one of the preferred embodiments of the present invention, the water-jet means 402 is adjustable with reference to preform end of the preform for achieving predetermined angle between the water-jet 401 and preform end.

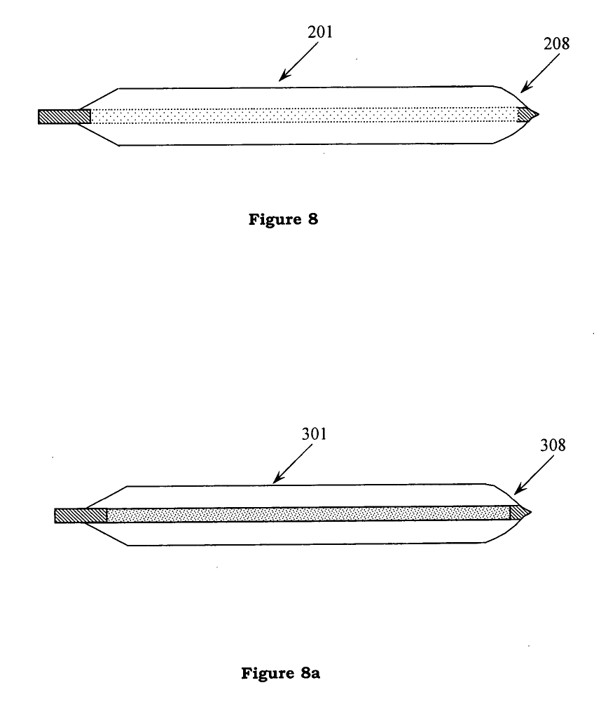

The accompanying FIG. 8 illustrates a mother preform 201 having preform cone 208 shaped or prepared in accordance with present invention which has been observed to have desired shape and dimensions including diameter.

The accompanying FIG. 8a illustrates a daughter preform 301 having preform cone 308 shaped or prepared in accordance with present invention which has been observed to have desired shape and dimensions including diameter.

Accordingly, the presently disclosed method for cone shaping or preparation at mother preform stage and at daughter preform stage totally avoids or eliminates step of heating of preform end for preparation of preform cone meaning thereby overcome all associated disadvantages, drawbacks and limitations of the step of heating the preform end, and hence avoids or eliminates step of highly controlled cooling of the preform end after preparation of preform cone, and also address the problems encountered during the process step of cone preparation just before the process step of fiber draw.

Further, with the adjustable capability of the water-jet means, it has been possible to produce or shape preform cone having precisely controlled cone of desired shape and dimensions, including desired diameter which is suitable for start of fiber draw without wastage of preform.

The preform cone shaped or prepared by employing present method has been observed to be free from formation of any defects thereby avoiding possibility of breakage, and hence, possibility of loss of fiber length during start of fiber draw step. Accordingly, the present method for preparation of cone results in exorbitant power and energy savings.

It is apparent from the present description that preparation or shaping of preform cone by employing present method is not only easy and convenient, but also highly time saving meaning thereby the overall process for cone preparation is not only easy, convenient and controlled, but also highly productive and economical for commercial applications.

It is also apparent from the foregoing that the present method for shaping or preparation of preform cone does not require heating of the preform in any complicated, sophisticated, expensive and specially built furnace, for example, hydroxyl flame burners, graphite resistance or induction furnace, plasma heating means, power full lasers for heating the preform end, and step of cooling in any complicated, sophisticated, expensive and specially built containers or vessels with specially built cooling means for controlled cooling of prepared preform cone. Therefore, the present method for preparation of preform cone has been found to be further economical for commercial purposes.

As the present method for shaping or preparation of preform cone does not require any step of heating in a hydroxyl flame burners, it avoids possibility of increase of hydroxyl contents of the preform during the step of cone preparation, and hence a preform produced has been found suitable for producing an optical fiber which has been found to have reduced transmission loss, particularly at about 1380 nm wavelength band and accordingly the preform produced has been found to be suitable for CDWM (16 Channels) applications.

As the present method for preparation or shaping of preform cone does not require step of heating with graphite resistance or in induction furnace, it avoids possibility of contamination of mother preform and daughter preform having desired preform cone prepared in accordance with present invention with oxidation products, for example ash, graphite particles etc., thereby possibility of transmission loss and poor strength of the fiber produced from such preform is avoided.

As the present method for preparation or shaping of preform cone does not require step of heating with high power lasers, such as carbon dioxide lasers for preparation of preform cone, it avoids losses on account of consumption of high power required to generate required high temperature meaning thereby the overall production cost is reduced, and possibility of thermal induced stress in the preform cone area which may shatter the preform to pieces is also avoided.

As the present method does not require a step of cooling the prepared or shaped preform cone, it has been found to avoid possibility of any non-uniform cooling or immediate cooling or abrupt cooling, and hence, possibility of formation of physical defects and stress in the preform cone.

Further, the fiber produced from the preform having preform cone of desired shape produced by employing present method for preparation or shaping of preform cone has been found to be not only having reduced transmission loss, but also having desired other optical parameters, for example, desired polarization mode dispersion, cutoff wavelength etc.

It is apparent from the foregoing description that the presently disclosed method for preparation or shaping of preform cone has overcome disadvantages, limitations and drawbacks of the prior art.

It may be noted that the term ‘shaping of preform cone’ as employed herein is intended to mean that the preform cone of the mother preform or daughter preform is shaped by employing present method to have a desired shape and dimensions including diameter. Further, the term ‘preparing preform cone’ as employed herein is intended to mean that the preform cone of desired shape or dimensions including diameter can be prepared by cutting the soot or glass at one end of the preform [mother preform or daughter preform].

It may be noted that various terms, for example adjustable water-jet means, water-jet, mandrel, soot porous body, hollow soot porous body, capillary, dehydrated soot porous body, sintered glass body, solid glass preform, core rod having reduced diameter, soot porous body having core rod, core rod, mother preform, soot preform, daughter preform, preform end, preform cone, sintered core rod etc. as employed herein are merely intended to illustrate the present invention and are not intended to restrict scope of the present invention. It is obvious for the persons skilled in the art that alternative terms may also be employed to describe the present method without deviating from the intended scope of the present invention.

It may also be noted that the presently disclosed method has been described with reference to ACVD method. However, the present method is suitable even for other alternative methods known for producing mother preform and daughter preform.

1. A process for shaping or preparation of preform cone of desired shape and dimensions including diameter characterized in that the preform cone is prepared at the mother preform stage without requiring the step of heating, particularly a step of heating the preform end of the mother preform to a very high temperature and without requiring a step of cooling, particularly a step of controlled cooling of the preform cone thus prepared wherein the preform cone is prepared by cutting the preform end or shaping the preform cone at one end of the mother preform by employing a high pressure water-jet.

2. A process for shaping or preparation of preform cone of desired shape and dimensions including diameter characterized in that the preform cone is prepared at the daughter preform stage without requiring the step of heating, particularly a step of heating the preform end of the daughter preform to a very high temperature and without requiring a step of cooling, particularly a step of controlled cooling of the preform cone thus prepared wherein the preform cone is prepared by cutting the preform end or shaping the preform cone at one end of the daughter preform by employing a high pressure water-jet.

3. A process as claimed in claim 1, wherein mother preform is prepared comprising the steps of:—
a) preparing the mandrel;
b) placing the mandrel over a lathe;
c) depositing soot particles on the mandrel to prepare a soot porous body;
d) removing the mandrel to form hollow soot porous body having capillary therethrough;
e) dehydrating the hollow soot porous body to form dehydrated soot porous body;
f) performing sintering step on dehydrated soot porous body to form sintered glass body; and
g) performing collapsing step to collapse the capillary of the sintered glass body to form solid glass preform, named as mother preform.

4. A process as claimed in claim 3, wherein the mother preform is further processed by steps of:—
h) performing the step of reducing the diameter of the solid glass preform produced in step-g) to form a core rod having reduced diameter;
i) overcladding the core rod having reduced diameter to form soot preform comprising soot porous body having core rod; and
j) performing sintering step on the soot preform having prepared preform cone to form a sintered preform, named as daughter preform.

5. A process as claimed in claim 1, wherein the water-jet means optionally comprise abrasive material.

6. A process as claimed in claim 1, wherein mother preform comprises a core and a clad and is provided with dummy glass handle on each opposite ends thereof for the purpose of handling and holding the preform during the step of cone preparation.

7. A process as claimed in claim 2, wherein the daughter preform comprises a core rod and a overclad wherein the extended parts on the opposite ends of the core rod serve the purpose of handle rods on each of the opposite ends of the core rod for handling and holding the preform during the step of cone preparation.

8. A process as claimed in claim 1, wherein mother preform before preform cone preparation step does not has desired cone shape structure on the opposite ends thereof.

9. A process as claimed in claim 1, wherein step of preform cone shaping or step of preform cone preparation is performed on one end of the mother preform after holding the preform in a suitable holding mechanism.

10. A process as claimed in claim 1, wherein the step of preform cone shaping or preform cone preparation is performed by allowing the water-jet from the water-jet means to fall on the selected end of the preform at an angle.

11. A process as claimed in claim 10, wherein said angle is selected from the range varying from about 40 to about 60 degree.

12. A process as claimed in claim 1, wherein the step of preform cone shaping or preform cone preparation is performed by allowing the water-jet from the water-jet means to fall on the selected end of the preform at a pressure.

13. A process as claimed in claim 12, wherein said pressure is selected from the range varying from about 4000 to about 8000 Kg/Cm².

14. A process as claimed in claim 1, wherein water-jet means is adjustable with reference to preform end of the preform for achieving predetermined angle between the water-jet and preform end.

15. A process as claimed in claim 3, wherein mother preform prepared in step-g) is subjected to a step of shaping of preform cone or preform cone preparation on one end thereof to have a preform cone of desired shape and dimensions including diameter by cutting the preform end or shaping the preform cone at one end thereof by a water-jet means.

16. A process as claimed in claim 4, wherein daughter preform prepared in step-j) is subjected to a step of shaping of preform cone or preform cone preparation on one end thereof to have a preform cone of desired shape and dimensions including diameter by cutting the preform end or shaping the preform cone at one end thereof by a water-jet means.

17. A process as claimed in claim 2, wherein daughter preform before preform cone preparation step does not has desired cone shape structure on the opposite ends thereof.

18. A process as claimed in claim 2, wherein step of preform cone shaping or step of preform cone preparation is performed on one end of the daughter preform after holding the preform in a suitable holding mechanism.

19. A mother preform as and when prepared by a process as claimed in claim 1, wherein said mother preform has a preform cone of desired shape and dimensions including diameter.

20. A daughter preform as and when prepared by a process as claimed in claim 2, wherein said daughter preform has a preform cone of desired shape and dimensions including diameter.

21. An optical fiber as and when prepared from mother preform as claimed in claim 19, wherein said optical fiber has reduced transmission loss, particularly at about 1380 nm wavelength band which is suitable for CDWM (16 Channels) applications.

22. An optical fiber as claimed in claim 21, wherein said fiber has reduced transmission loss and desired optical parameters selected from polarization mode dispersion and cutoff wavelength.

23. An optical fiber as and when prepared from daughter preform as claimed in claim 20, wherein said fiber has reduced transmission loss, particularly at about 1380 nm wavelength band, which is suitable for CDWM (16 Channels) applications.

24. An optical fiber as claimed in claim 23, wherein said fiber has reduced transmission loss and desired optical parameters selected from polarization mode dispersion and cutoff wavelength.
